(19) United States
(12) Patent Application Publication
(10) Pub. No.: US 2016/0078576 A1
(43) Pub. Date: Mar. 17, 2016

(54) CLOUD-BASED VEHICLE MONITORING SYSTEMS AND METHODS

(71) Applicants: Zhong SU, Charlotte, NC (US); Hua YANG, Charlotte, NC (US); Donald BLACK, Charlotte, NC (US)

(72) Inventors: Zhong SU, Charlotte, NC (US); Hua YANG, Charlotte, NC (US); Donald BLACK, Charlotte, NC (US)

(73) Assignee: FORTRESS SYSTEMS INTERNATIONAL, INC., Charlotte, NC (US)

(21) Appl. No.: 14/488,992

(22) Filed: Sep. 17, 2014

(51) Int. Cl. G06Q 50/20; G07C 5/00; H04N 5/247; H04N 5/91; H04N 5/77; G08G 1/00; G06Q 10/06

(52) U.S. Cl. CPC G06Q 50/205; G08G 1/20; G07C 5/006; G06Q 10/0631; H04N 5/91; H04N 5/77; H04N 5/247

(57) ABSTRACT

A fleet management system and method includes a monitoring system equipped in each of a plurality of vehicles, wherein the monitoring system includes a network interface to a wireless network and a location determining device; and a back-end system communicatively coupled to the monitoring system in each of the plurality of vehicles; wherein the back-end system is configured to: communicate with a plurality of passengers to provide real-time updates based on the monitoring system; and monitor and manage a fleet including the plurality of vehicles by an administrator based on data from the monitoring system.

### FIELD OF THE DISCLOSURE

The present disclosure relates generally to computer networking systems and methods. More particularly, the present disclosure relates to cloud-based vehicle monitoring systems and methods.

### BACKGROUND OF THE DISCLOSURE

With respect to public transportation and the like, monitoring a large fleet of vehicles can be difficult. The monitoring can include both in-vehicle monitoring (e.g., activity in each vehicle) and out-of-vehicle monitoring (e.g., location of each vehicle). For example, school districts may have hundreds of school busses that are concurrently in operation. It would be advantageous to have a single system to monitor all activity associated with each bus from the perspective of the school district. Additionally, it would be advantageous to include activity monitoring from the perspective of parents and students. This can also apply to municipal bus systems, taxis, subways, light-rail, trains, and the like. With the prevalence of smart devices, there are many opportunities to optimize monitoring, notification, etc. of vehicles and the like.

### BRIEF SUMMARY OF THE DISCLOSURE

In an exemplary embodiment, a fleet management system includes a monitoring system equipped in each of a plurality of vehicles, wherein the monitoring system comprises a network interface to a wireless network and a location determining device; and a back-end system communicatively coupled to the monitoring system in each of the plurality of vehicles; wherein the back-end system is configured to: communicate with a plurality of passengers to provide real-time updates based on the monitoring system; and monitor and manage a fleet comprising the plurality of vehicles by an administrator based on data from the monitoring system.

In another exemplary embodiment, a fleet management method includes operating a plurality of vehicles each comprising a monitoring system comprising a network interface to a wireless network and a location determining device; operating a back-end system communicatively coupled to the monitoring system in each of the plurality of vehicles; communicating to passengers by the back-end system to provide notifications and updates associated with the plurality of vehicles; and managing the plurality of vehicles through the back-end system by an administrator.

In yet another exemplary embodiment, a vehicle monitoring system includes a plurality of cameras, a mobile digital video recorder, a network interface, a data store, a location determining device, and a processor, each communicatively coupled therebetween; and memory storing instructions that, when executed, cause the processor to: process video from the plurality of cameras; store the video in the data store or provide the video to a back-end system via the network interface; and provide location updates from the location determining device to the back-end system.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram illustrates a vehicle monitoring system;

FIG. 2 is various diagrams of interiors of busses with different cameras included therein for the vehicle monitoring system of FIG. 1;

FIG. 3 is a diagram of an interior of an exemplary vehicle equipped with the in-vehicle monitoring system of FIG. 1 and four cameras;

FIG. 4 is a screen shot of a map which can be displayed through the back-end system;

FIG. 5 is a block diagram of a server which may be used in the system of FIG. 1 or standalone;

FIG. 6 is a block diagram of a mobile device which may be used in the system of FIG. 1 or with any other cloud-based system;

FIG. 7 is a flowchart of a user method for a parent/student and a school bus with the vehicle monitoring system;

FIG. 8 is a flowchart of an operator method for an administrator of a fleet of school busses with the vehicle monitoring system;

FIG. 9 is a flowchart of a user method for a rider and public transportation with the vehicle monitoring system;

FIG. 10 is a flowchart of a user method for fleet administration in public transportation with the vehicle monitoring system; and

FIG. 11 is a flowchart of a user method for a rider and public transportation with the vehicle monitoring system.

### DETAILED DESCRIPTION OF THE DISCLOSURE

In various exemplary embodiments, cloud-based vehicle monitoring systems and methods are described. The cloud-based vehicle monitoring systems and methods include a monitoring system in each vehicle that is communicatively coupled to a back-end system. Passengers (e.g., students, parents, riders, etc.) can access information from the back-end system via a mobile device. Operators, administrators, etc. can monitor and manage a fleet from the back-end system. Operators and administrators face numerous challenges such as fleet management, optimization, efficiency, etc. A simple example includes rain and numerous calls to an operator when a school bus is late to the bus stop. The cloud-based vehicle monitoring systems and methods in the various exemplary embodiments described herein provide an efficient solution to enable the various stakeholders—Operators, administrators, students, parents, riders—efficiency.

### Vehicle Monitoring System

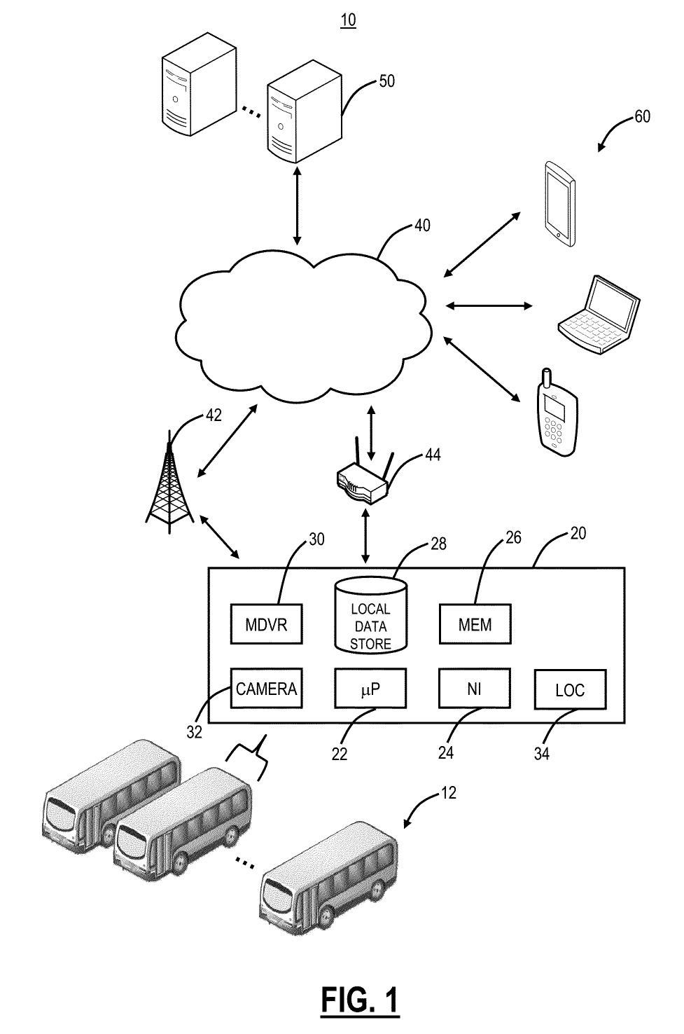

Referring to FIG. 1, in an exemplary embodiment, a network diagram illustrates a vehicle monitoring system 10. The vehicle monitoring system 10 includes a plurality of vehicles 12 each includes an in-vehicle monitoring system 20 contained therein. The in-vehicle monitoring system 20 includes a processor 22, a network interface 24, memory 26, a local data store 28, a mobile digital video recorder (MDVR) 30, one or more cameras 32, and a location determining device 34. The in-vehicle monitoring system 20 for each of the vehicles 12 connects to a network 40 (e.g., the Internet) via either a wireless provider network 42 or a wireless local area network 44. The in-vehicle monitoring system 20 can connect, through the network 40, to a back-end system 50. Additionally, users can access the back-end system 50 via devices 60 through the network 40 for performing various functions based on data associated with the in-vehicle monitoring system 20 as is described herein

### In-Vehicle Monitoring System

The in-vehicle monitoring system 20 includes a physical housing for the various components 22, 24, 26, 28, 30, 32, 34 and mounts in the interior of one of the vehicles 12, e.g., a bus. It should be appreciated by those of ordinary skill in the art that FIG. 1 depicts the in-vehicle monitoring system 20 in an oversimplified manner, and a practical embodiment may include additional components and suitably configured processing logic to support known or conventional operating features that are not described in detail herein. The components (22, 24, 26, 28, 30, 32, 34) are communicatively coupled via a local interface which may be, for example but not limited to, one or more buses or other wired or wireless connections. The local interface may have additional elements, which are omitted for simplicity, such as controllers, buffers (caches), drivers, repeaters, and receivers, among many others, to enable communications. Further, the local interface may include address, control, and/or data connections to enable appropriate communications among the aforementioned components.

The processor 22 is a hardware device for executing software instructions. The processor 22 may be any custom made or commercially available processor, a central processing unit (CPU), an auxiliary processor among several processors associated with the in-vehicle monitoring system 20 a semiconductor-based microprocessor (in the form of a microchip or chip set), or generally any device for executing software instructions. When the in-vehicle monitoring system 20 is in operation, the processor 22 is configured to execute software stored within the memory 26, to communicate data to and from the memory 26, and to generally control operations of the in-vehicle monitoring system 20 pursuant to the software instructions.

The network interface 24 may be used to enable in-vehicle monitoring system 20 to communicate on a network, such as the network 40, a wide area network (WAN), a local area network (LAN), and the like, etc. The network interface 24 may include, for example, a wireless local area network (WLAN) card or adapter (e.g., 802.11a/b/g/n). The network interface 24 may include address, control, and/or data connections to enable appropriate communications on the network. The network interface 24 may also include access to the wireless provider network 42 such as through Long Term Evolution (LTE), etc. In an exemplary embodiment, the network interface 24 can also act as an access point (AP) locally for passengers. This can be used to provide network access to passengers through their associated smart devices.

The data store 28 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 28 may incorporate electronic, magnetic, optical, and/or other types of storage media. The data store 28 is located internal to the in-vehicle monitoring system 20, in a non-tamper proof and non-accessible manner except for authorized personnel.

The memory 26 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 26 may incorporate electronic, magnetic, optical, and/or other types of storage media. Note that the memory 26 may have a distributed architecture, where various components are situated remotely from one another, but can be accessed by the processor 22. The software in memory 26 may include one or more software programs, each of which includes an ordered listing of executable instructions for implementing logical functions. The software in the memory 26 includes a suitable operating system (O/S) and one or more programs. The operating system 26 essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The location determining device 34 can determine a real-time location of the vehicle 12 associated with the in-vehicle monitoring system 20. Additionally, the location determining device 34 can track the vehicle 12's movement, speed, route, etc. as well as providing directions. In an exemplary embodiment, the location determining device 34 can utilize Global Positioning System (GPS). Note, any technique is contemplated for location determination. The location determining device 34 can continually update the processor 22 of location for use in the various functionality of the in-vehicle monitoring system 20 described herein.

### Mobile Digital Video Recorder

The MDVR 30 is configured to capture video from the one or more cameras 32 showing the interior of the vehicle 12. The MDVR 30 provides an operator of a fleet of the vehicles 12 with more features, functionality, flexibility and expansion. The MDVR 30 provides Live-Viewing video and recording of video to provide insight to driver conduct, passenger conduct, vehicle location route tracking, speed check, and camera functionality from any remote location. The MDVR 30 provides viewing multiple of the cameras 32 in the vehicle 12 at once; listening to a selectable audio channel; conversations between a remote user and the MDVR 30; viewing multiple vehicle 12 cameras at once; watermarking of vehicle identification, date, and time on recorded video; mapping window for location viewing; vehicle speed in map window; etc.

The MDVR 30 provides two modes of video—passive recording which can be stored locally in the local data store 28 or provided over the network interface 24 and active live viewing which is provided over the network interface 24. For passive recording, users can retrieve saved video and data from either the local data store 28 such as through a Secure Digital (SD) Card or a hard drive (depending on the unit). In an exemplary embodiment, retrieval of the record video can be done by removing the digital media from the MDVR 30 and uploading it at the back-end system 50 where the saved video and data can be viewing on a computer through playback software. In an another exemplary embodiment, the saved video and data on the MDVR 30 can be uploaded via the WLAN 44 (Wi-Fi) when the vehicle 12 is at a central location or a location with WLAN access. With the passive solution, users have access to various reporting features through the back-end system 50 which include: Vehicle Route Tracking; Vehicle Route Report; Start/Stop Engine Reports; Speed Reports; Custom Trigger Report (example: Stop Arm, Wheel Chair Lift); Geo Fencing; and the like.

For live viewing, the live view solution provides up-to date information on vehicle fleets and live video. The live video can be provided through the back-end system 50 through the network interface 24 which can include a Wi-Fi canopy, cellular network connection, mesh network, or the like. Dispatch can look in on any online vehicle with a connection in real time. The solution in addition to reporting also includes vehicle tracking that can customized based on each user (example: each dispatcher can view customize vehicle numbers per their account). The live view solution can provide quality video and audio; vehicle route tracking; ability to increase fleet productivity; ability to increase security; dispatcher management. This scalable solution offers fleet operators the ability to manage in live while also having access to saved information for archiving. Also, the housing for the in-vehicle monitoring system 20 can be hardened and tamper-proof.

In an exemplary embodiment, the MDVR 30 can support up to four cameras 32, twelve cameras 32, and any number of cameras 32, and simultaneous recording; H.264 Compression; an SD Card with Lock; 8 independent sensors for capturing sensory indicators; calendar and event search to catalog video; various storage options based on the size of the local data store 28; a user interface for control—accessed both locally or via the network 40; date, time and vehicle number watermarking; user selectable audio channel from any of the cameras 12; variety of configurable camera views; and the like. The in-vehicle monitoring system 20 can provide synchronized vehicle tracking; vehicle location and speed logging; GPS and vehicle mapping; start/stop engine reports; stop arm reporting (school bus); and the like.

The MDVR 30 can also operate in an on-demand mode where real-time video is provided, based on a request. The request can be from a bus driver, such as through hitting a panic button, from an operator or administrator, such as through the back-end system 50, or from a remote user, such as a parent through the device 60 and the back-end system 50. The idea behind the on-demand mode is to provide video over the wireless provider network 42 when needed since bandwidth is a premium over wireless networks.

### Camera

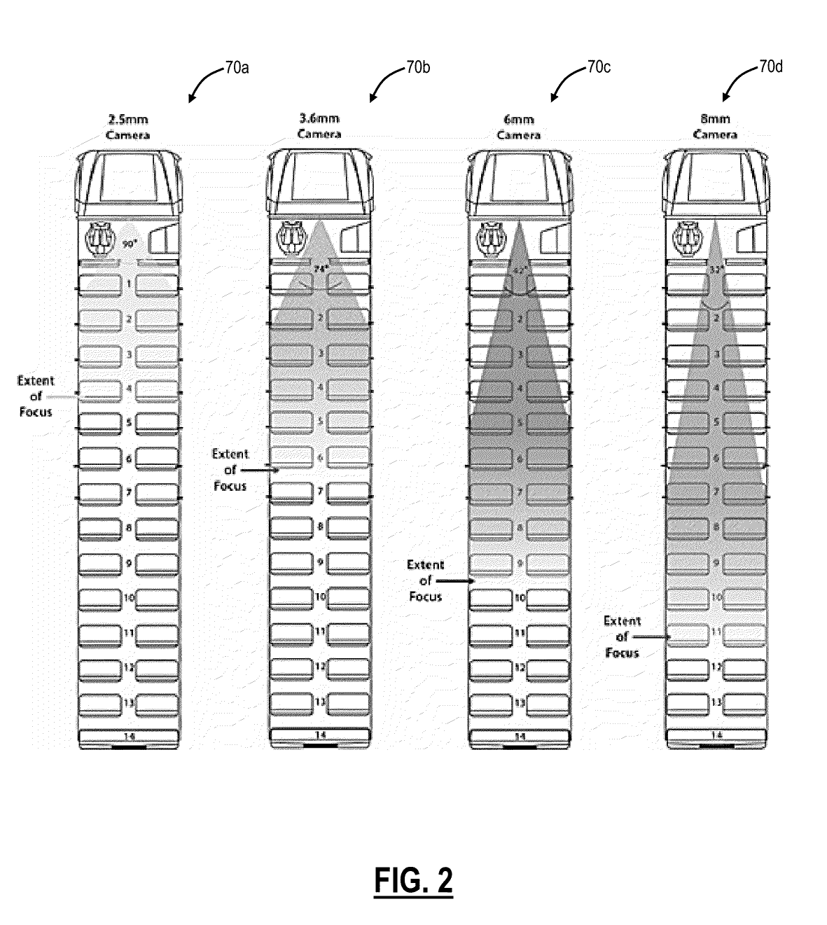

Referring to FIG. 2, in an exemplary embodiment, diagrams illustrate interiors of busses 70a, 70b, 70c, 70d with different cameras 32 included therein. The camera 32 can include lens with different focal lengths such as 2.5 mm, 3.6 mm, 6 mm, and 8 mm. The bus 70a includes a 2.5 mm lens which has an extent of focus up to about a fourth row, the bus 70b includes a 3.6 mm lens which has an extent of focus up to about a sixth row, the bus 70c includes a 6 mm lens which has an extent of focus up to about a ninth row, and the bus 70d includes a 6 mm lens which has an extent of focus up to about an eleventh row. The cameras 32 can be high-resolution, include infrared light emitting diodes (LEDs) for low-light recordings, housed in a tamper-resistant and vandal-proof dome attached to a ceiling in the vehicle 12, include an anti-vibration mounting base, include a hidden audio microphone with volume control, and the like.

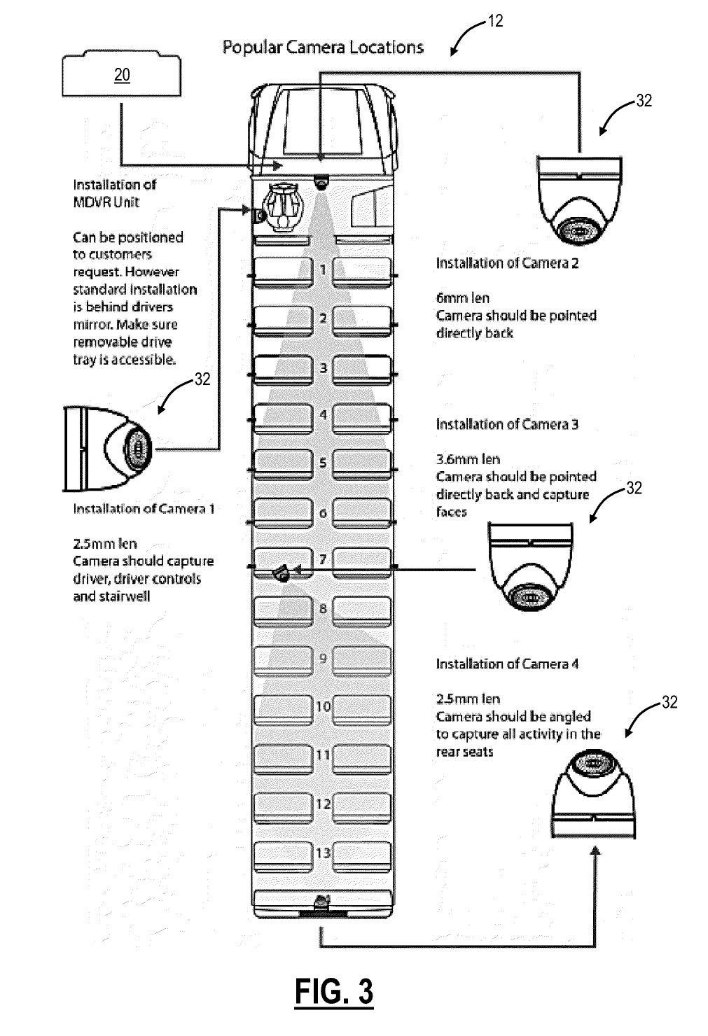

Referring to FIG. 3, in an exemplary embodiment, a diagram illustrates an interior of an exemplary vehicle 12 equipped with the in-vehicle monitoring system 20 and four cameras 32. In this example, the in-vehicle monitoring system 20 is located at a front of the vehicle 12. The vehicle 12 can include a first camera 32 covering a driver, and this can be a 2.5 mm lens; a second camera 32 at a front of the vehicle covering the passengers, and this can be a 6 mm lens; a third camera 32 at a middle of the vehicle covering the passengers, and this can be a 3.6 mm lens, and a fourth camera 32 at a back of the vehicle covering the passengers, and this can be a 2.5 mm lens. The second camera 32's intent is to record the activities on the entire vehicle from the front facing back. The usual camera lens will be a 6 mm or 8 mm. Using the 6 mm or 8 mm lens focus is too narrow to capture the bus operator or stairwell. The first camera 32 is mounted by the driver to capture people entering and exiting the vehicle. Some district operators want this angle specifically for stairwell events, but another purpose of this camera angle is to monitor the drivers' behavior and interaction with passengers. The best lens for this camera location is a 2.5 mm for its wide angle view capabilities.

If a mid-cabin camera is installed, the third camera 32, using a 3.6 MM camera is a good option. The third camera 32 is mounted in the mid cabin area and directed toward the rear of the vehicle 12. This provides another vantage point on passengers furthest from operator's supervision. The best lens for this camera location is a 3.6 mm lens providing further focus than a 2.5 mm lens and better wide angle view than a 6 mm. The fourth camera 32 is mounted in the rear of the cabin to view the behavior of students furthest from the bus driver's attention. This camera is mounted at a downward angle to see into the last two rows. The best lens for this camera location is a 2.5 mm for its wide angle view capabilities.

The cameras 32 are connected to the MDVR 30 in the in-vehicle monitoring system 20. Note, the vehicle 12 can also be smaller than a school bus or a municipal bus. For example, in a taxi, a single camera can be used such as a 2.5 mm lens. Various other options are contemplated.

### Video Playback Viewing

The back-end system 50 includes various functions that can be implemented through software. For example, the vehicle monitoring system 10 can include mobile video playback viewing software was designed to allow users to view the captured video recordings with GPS data, audio, and sensory indicators. This software is easy to use and is the vital element to enforcing policy and protecting passengers. Furthermore, through the back-end system 50 integration in the cloud, it allows interaction by operators of the vehicles 12 as well as passengers including parents and students. Users using this video playback viewing software will have the ability to easily locate, retrieve, view, save and share video data. This software will offer an abundance of ways to allow users from remote locations to streamline important data.

The playback software, through the back-end system 50, can provide: Multiple Camera Viewing; Selectable Audio Channel; Calendar & Time Search; Event File Search; Date & Time Watermarking; Create Short Video Clips; Still Image Photos; Saving and Sharing of Data; Video File Encryption; Multi-Level Users.

### Reporting

The back-end system 50 enables various reporting options—both real-time, upcoming alerts, and historical reporting. The reports can be for internal use—by operators, to improve efficiency, performance, correct problems, etc. as well as for external use—by passengers, parents, etc.—to provide notifications, updates, alerts, etc. Exemplary reports can include, without limitation, wheelchair deployments, door openings, stops, average speed, route, on-time performance, brakes applied and the list goes on.

The vehicle monitoring system 10 can be a data logger system which tracks all activity associated with a route including, without limitation, number of passengers, identity of passengers, location, speed, stops, etc. The vehicle monitoring system 10 can track the number of passengers, who gets on and off, etc. In this manner, the vehicle monitoring system 10 can be utilized to optimize operations, provide reassurance that a passenger is on board, and the like.

Also, the various notifications and events described herein can also be incorporated into various social networks and the like. For example, events can be distributed via push/pull notifications to the mobile devices of parents, students, and/or passengers as well as directly posted onto social networks by the vehicle monitoring system 10. The vehicle monitoring system 10 can include Application Programming Interfaces (APIs) to access social networks and mobile phone network notifications simultaneously.

### Passenger Identification

Conventionally, determining whether or not a passenger is on a bus, train, etc. is difficult and unreliable. Specifically, conventional techniques can include a passenger check-in which is only as reliable if everyone consistently uses the check-in. This process can be especially difficult on school buses with students. The vehicle monitoring system 10 can perform various automated techniques to identify the number of passengers, the location of passengers, and the identity of passengers.

The bus, train, etc. can be equipped with seat sensors showing whether each seat is occupied or not and providing such information to the back-end system 50. In this manner, the back-end system 50 can create reports of seat occupancy over time over the route to determine efficiency, usage, and optimization. Alternatively, the bus, train, etc. can be equipped be low-cost near-field communication (NFC) or beacon technology which can link with a mobile device associated with a passenger. For example, the beacon technology could include Bluetooth Low Energy, iBeacon (from Apple), or the like which are configured to provide data such as user identity or the like from an associated mobile device.

As shown in FIG. 3, there is complete video coverage of the bus (or train) in the vehicle monitoring system 10. Note, the first camera 32 covers both the driver as well as the entrance to the bus. The vehicle monitoring system 10 contemplates a facial recognition process where entering passengers are identified visually by the first camera 32, the in-vehicle monitoring system 20, and/or the back-end system 50 working in tandem. For example, in the context of a school bus, the school will typically have head shots of all students linked to names, and this data can be securely used in the back-end system 50 to identify which students enter and exit the bus. The other cameras can be used to determine which seat the students are occupying such as by tracking them down the school bus aisle. Various facial identification techniques can be used.

This is advantageous in the context of push notifications described herein. For example, by identifying a specific student entering the bus, the vehicle monitoring system 10 can automatically notify a parent through a push notification. Since this process is automated, there is more reliability and parents can have more assurance, as opposed to having the student manually check in. Also, the vehicle monitoring system 10 will have knowledge of the student's location on the bus so that is the parent wants video of the bus, the parent can receive only the feed showing her student, making a more efficient system.

### Mapping and Real-Time Monitoring

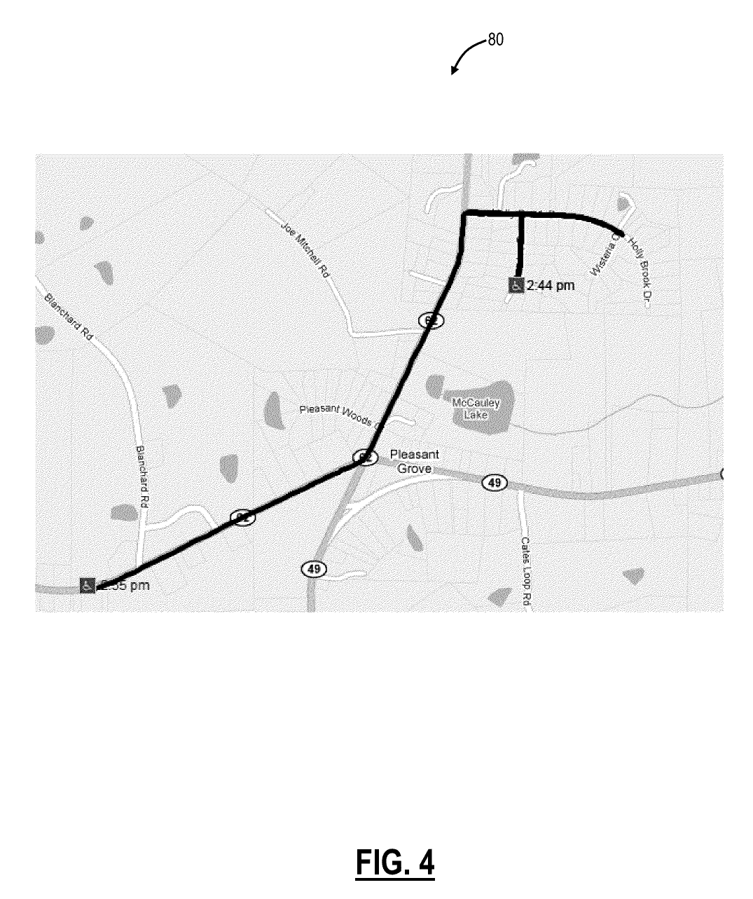

Referring to FIG. 4, in an exemplary embodiment, a screen shot illustrates a map 80 which can be displayed through the back-end system 50. The map 80 is shown with a single vehicle 12 and a trip is highlighted on the map 80 showing stops and times. In various exemplary embodiments, the map 80 can show a plurality of vehicles 12—in real-time as well as historical. Here, an administrator can monitor, from a single interface, an entire fleet of vehicles 12. Furthermore, the administrator can select any of the vehicles 12 and view various statistical data that is maintained by the vehicle monitoring system 10 including viewing real-time video, communicating directly to the driver, etc.

### Server for Back-End System

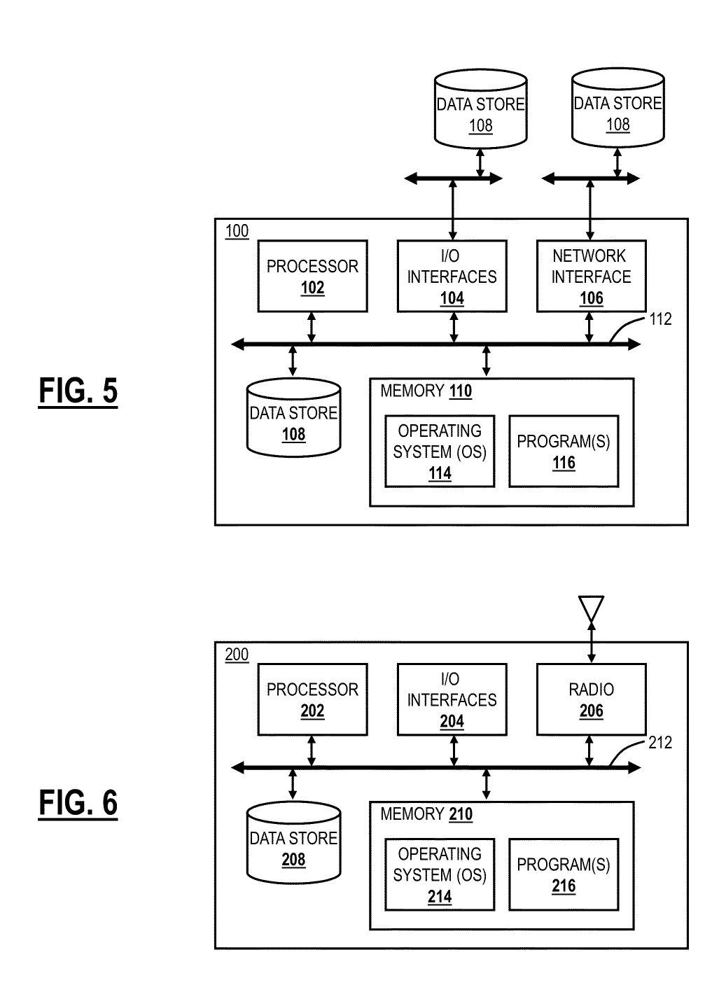

Referring to FIG. 5, in an exemplary embodiment, a block diagram illustrates a server 100 which may be used in the back-end system 50, in other systems, or standalone. The server 100 may be a digital computer that, in terms of hardware architecture, generally includes a processor 102, input/output (I/O) interfaces 104, a network interface 106, a data store 108, and memory 110. It should be appreciated by those of ordinary skill in the art that FIG. 5 depicts the server 100 in an oversimplified manner, and a practical embodiment may include additional components and suitably configured processing logic to support known or conventional operating features that are not described in detail herein. The components (102, 104, 106, 108, and 110) are communicatively coupled via a local interface 112. The local interface 112 may be, for example but not limited to, one or more buses or other wired or wireless connections, as is known in the art. The local interface 112 may have additional elements, which are omitted for simplicity, such as controllers, buffers (caches), drivers, repeaters, and receivers, among many others, to enable communications. Further, the local interface 112 may include address, control, and/or data connections to enable appropriate communications among the aforementioned components.

The processor 102 is a hardware device for executing software instructions. The processor 102 may be any custom made or commercially available processor, a central processing unit (CPU), an auxiliary processor among several processors associated with the server 100, a semiconductor-based microprocessor (in the form of a microchip or chip set), or generally any device for executing software instructions. When the server 100 is in operation, the processor 102 is configured to execute software stored within the memory 110, to communicate data to and from the memory 110, and to generally control operations of the server 100 pursuant to the software instructions. The I/O interfaces 104 may be used to receive user input from and/or for providing system output to one or more devices or components. User input may be provided via, for example, a keyboard, touch pad, and/or a mouse. System output may be provided via a display device and a printer (not shown). I/O interfaces 104 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 106 may be used to enable the server 100 to communicate on a network, such as the Internet, a wide area network (WAN), a local area network (LAN), and the like, etc. The network interface 106 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 106 may include address, control, and/or data connections to enable appropriate communications on the network. A data store 108 may be used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media. In one example, the data store 108 may be located internal to the server 100 such as, for example, an internal hard drive connected to the local interface 112 in the server 100. Additionally in another embodiment, the data store 108 may be located external to the server 100 such as, for example, an external hard drive connected to the I/O interfaces 104 (e.g., SCSI or USB connection). In a further embodiment, the data store 108 may be connected to the server 100 through a network, such as, for example, a network attached file server.

The memory 110 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 110 may incorporate electronic, magnetic, optical, and/or other types of storage media. Note that the memory 110 may have a distributed architecture, where various components are situated remotely from one another, but can be accessed by the processor 102. The software in memory 110 may include one or more software programs, each of which includes an ordered listing of executable instructions for implementing logical functions. The software in the memory 110 includes a suitable operating system (O/S) 114 and one or more programs 116. The operating system 114 essentially controls the execution of other computer programs, such as the one or more programs 116, and provides scheduling, input-output control, file and data management, memory management, and communication control and related services. The one or more programs 116 may be configured to implement the various processes, algorithms, methods, techniques, etc. described herein.

### Mobile Device for Accessing Back-End System

Referring to FIG. 6, in an exemplary embodiment, a block diagram illustrates a mobile device 200, which may be used in the vehicle monitoring system 10 or the like. For example, the mobile device 200 can be one of the devices 60. The mobile device 200 can be a digital device that, in terms of hardware architecture, generally includes a processor 202, input/output (I/O) interfaces 204, a radio 206, a data store 208, and memory 210. It should be appreciated by those of ordinary skill in the art that FIG. 6 depicts the mobile device 200 in an oversimplified manner, and a practical embodiment may include additional components and suitably configured processing logic to support known or conventional operating features that are not described in detail herein. The components (202, 204, 206, 208, and 202) are communicatively coupled via a local interface 212. The local interface 212 can be, for example but not limited to, one or more buses or other wired or wireless connections, as is known in the art. The local interface 212 can have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 can be any custom made or commercially available processor, a central processing unit (CPU), an auxiliary processor among several processors associated with the memory 210, a semiconductor-based microprocessor (in the form of a microchip or chip set), or generally any device for executing software instructions. When the mobile device 200 is in operation, the processor 202 is configured to execute software stored within the memory 210, to communicate data to and from the memory 210, and to generally control operations of the mobile device 200 pursuant to the software instructions. In an exemplary embodiment, the processor 202 may include a mobile optimized processor such as optimized for power consumption and mobile applications. The I/O interfaces 204 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 204 can also include, for example, a serial port, a parallel port, a small computer system interface (SCSI), an infrared (IR) interface, a radio frequency (RF) interface, a universal serial bus (USB) interface, and the like. The I/O interfaces 204 can include a graphical user interface (GUI) that enables a user to interact with the memory 210. Additionally, the I/O interfaces 204 may further include an imaging device, i.e. camera, video camera, etc.

The radio 206 enables wireless communication to an external access device or network. Any number of suitable wireless data communication protocols, techniques, or methodologies can be supported by the radio 206, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); Land Mobile Radio (LMR); Digital Mobile Radio (DMR); Terrestrial Trunked Radio (TETRA); Project 25 (P25); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media.

The memory 210 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 can include one or more software programs, each of which includes an ordered listing of executable instructions for implementing logical functions. In the example of FIG. 6, the software in the memory 210 includes a suitable operating system (O/S) 214 and programs 216. The operating system 214 essentially controls the execution of other computer programs, and provides scheduling, input-output control, file and data management, memory management, and communication control and related services. The programs 216 may include various applications, add-ons, etc. configured to provide end user functionality with the mobile device 200. For example, exemplary programs 216 may include, but not limited to, a web browser, social networking applications, streaming media applications, games, mapping and location applications, electronic mail applications, financial applications, and the like. In a typical example, the end user typically uses one or more of the programs 216 along with a network. The programs 216 can include an application or “app” which provides various functionality in communication with the back-end system 50 including location tracking, push notifications, geo-fencing, etc.

### School Bus Operations

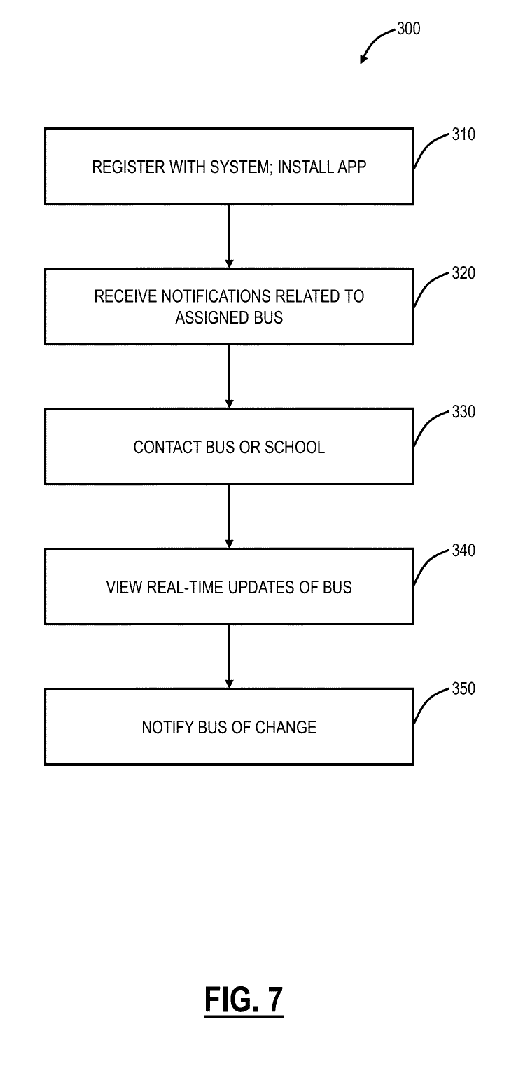

Referring to FIG. 7, in an exemplary embodiment, a flowchart illustrates a user method 300 for a parent/student and a school bus with the vehicle monitoring system 10. The user method 300 describes exemplary operations for a parent and/or student using the vehicle monitoring system 10. Here, various school busses, as the vehicles 12, are equipped with the monitoring system 20 which is communicatively coupled to the back-end system 50. The parent/student can access the back-end system 50 with the mobile device 200 for performing various functionality such as described in the user method 300. The user method 300 includes registration with the back-end system 50 and/or installing an application on the mobile device 200 (step 310). Here, the parent/student registers such that the back-end system 50 knows which vehicle 12 is associated with the parent/student. The parent/student can also install an application (e.g., from the App Store, Android Marketplace, Google Play, Windows Store, etc.) which can provide push notifications, a user interface, etc. with the back-end system 50. In the back-end system 50, the parent/student is assigned to the appropriate vehicle 12 for interaction.

The parent/student can receive notifications related to the assigned bus (step 320). For example, the user method 300 can provide push notifications (e.g., bus is running late, bus will arrive at 7:34 am, a new driver is operating the bus, etc.). Also, the parent/student can obtain real-time location of the bus, e.g. on a map, etc. Thus, parents can locate a school bus in real time by using Smart Handheld Device (e.g. smart phone), and generate students on and off report. The parent/student can contact the bus or school (step 330). For example, parents can contact with school and bus driver by using Smart Handheld Device (e.g. smart phone) at any time, ask for leave times, or change pick up location. For example, parents can notify the bus and/or school on days when a student is not riding (e.g., out sick, being driven, etc.). Also, the parents can receive a notification if their student is not on the bus and confirm that it is an excused absence. This information can also be provided to the school administrator. The parent can also contact the bus/school and provide information, e.g. student forgot his/her lunch, book bag, etc. The school bus can include assigned seating with each seat including an occupant sensor. In this manner, the presence/absence of each student can be easily detected and relayed to the back-end system 50. This provides parents, schools, and bus drivers with a convenient method to detect who is missing.

The parent/student can view real-time updates of the bus (step 340). Again, this can include determining an exact location as well as whether or not the student is on the bus. Also, the parent can receive real-time video from the interior of the bus through the monitoring system 20. This information is provided to the back-end system 50 already and can be easily provided to parents via the cloud. Also, the parent/student can notify the bus of changes (step 350) such as new pick up locations, switching to other means of transportation, etc.

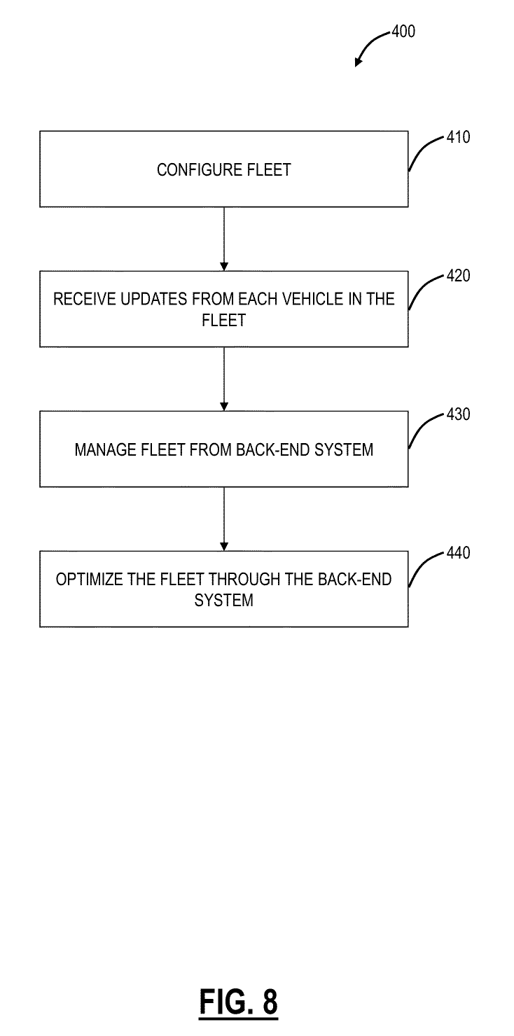

Referring to FIG. 8, in an exemplary embodiment, a flowchart illustrates an operator method 400 for an administrator of a fleet of school busses with the vehicle monitoring system 10. The operator method 400 describes exemplary operations for a fleet administrator or the like using the vehicle monitoring system 10. The operator method 400 can operate along with the user method 300 and contemplates a similar architecture in the vehicle monitoring system 10. The operator method 400 includes configuring a fleet of busses (step 410). Here, each vehicle 12 is equipped with the monitoring system 20 and configured appropriately, i.e. network access, unique identifiers, etc.

Once the busses are in the field, the back-end system 50 can continuously receive updates from each vehicle in the fleet (step 420). The updates can include real-time location, occupants, speed, trip history, video, and the like. The video can be real-time streamed or uploaded from stored images. Also, updates can include maintenance events, e.g. bus X is broken down or has a flat tire. This can be used for remedial actions. The back-end system 50 can be used to manage the fleet (step 430). The back-end system 50 can provide detailed school bus Key Performance Indicators (KPI) report by collecting real time data, including cost, student number, maximum riding hours, maximum riding distance, operating cost per bus, and fleet operating cost. The back-end system 50 can optimize the fleet (step 440). The back-end system 50 can provide fleet management recommendations, bus accessory recommendations, and provide finance/quality assurance. The back-end system 50 collects real time data of school bus, develops bus maintenance plans, changes bus rotation schedule, and informs bus maintenance department and supplier.

### Bullying Prevention

In an exemplary embodiment, the vehicle monitoring system 10 can assist in reducing bullying or physical encounters on the school bus. Here, the vehicle monitoring system 10 can record an entire route, and when there is an incident on the school bus, school administrators can review the video to determine cause and to provide the appropriate discipline. In this manner, it is expected that students will be less likely to provoke such events knowing that a teacher or administrator has the access to determine what happened rather than relying on the conflicting stories of participants. This process is also applicable to the other variations here for public transportation, i.e. knowing someone could be watching instills discipline in the passengers.

Using the bullying example for illustration purposes, there can be legal and privacy constraints that prevent direct video and/or audio access to live video feeds on the bus, train, etc. However, the monitoring system 20 can still record the video and audio for future access by appropriate administrators. Also, there vehicle monitoring system 10 can also preserve privacy concerns by allowing only video access without audio—enabling a remote user to see everything is okay on the bus, but not to hear private conversations.

### Public Transportation Operations

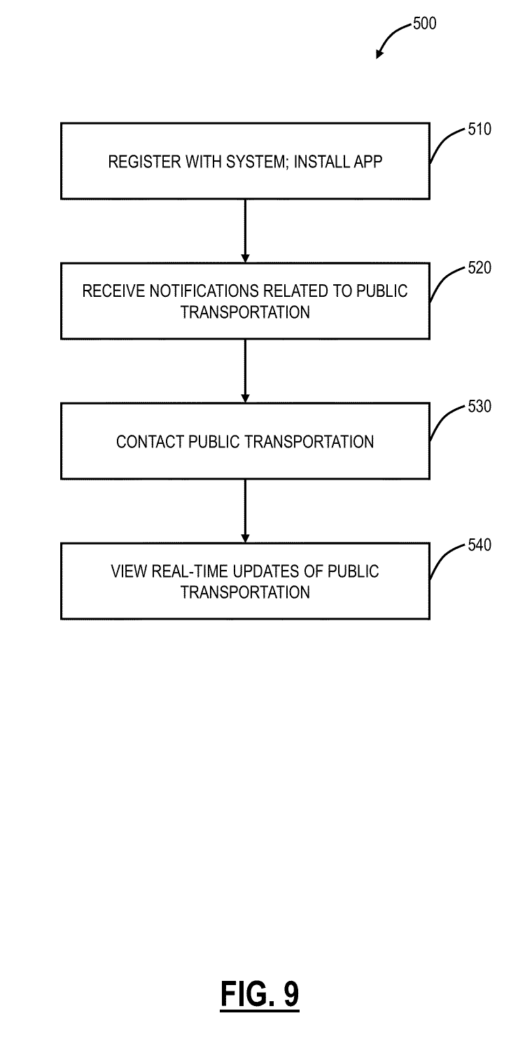

Referring to FIG. 9, in an exemplary embodiment, a flowchart illustrates a user method 500 for a rider and public transportation with the vehicle monitoring system 10. The user method 500 describes exemplary operations for a rider using the vehicle monitoring system 10. Here, various public transportation vehicles (e.g., buses, trains, subways, etc.) are equipped with the monitoring system 20 which is communicatively coupled to the back-end system 50. The rider can access the back-end system 50 with the mobile device 200 for performing various functionality such as described in the user method 500. The user method 500 includes registration with the back-end system 50 and/or installing an application on the mobile device 200 (step 510). Here, the rider registers such that the back-end system 50. The parent/student can also install an application (e.g., from the App Store, Android Marketplace, Google, Play, Windows Store, etc.) which can provide push notifications, a user interface, etc. with the back-end system 50.

The rider can receive notifications related to public transportation (step 520). For example, the rider can download transportation schedule in real time by using Smart Handheld Device. The rider can see real-time location of buses, trains, subways, etc. The rider can send a riding request through Smart Handheld Device or personal computer (step 530). The rider can view real-time updates of public transportation (step 540)

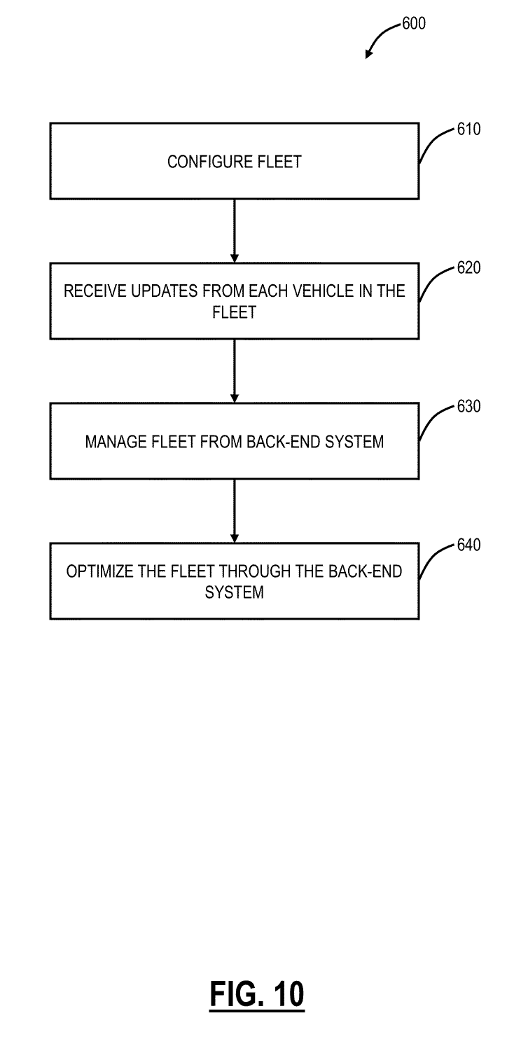

Referring to FIG. 10, in an exemplary embodiment, a flowchart illustrates an administration method 600 for fleet administration in public transportation with the vehicle monitoring system 10. The administration method 600 describes exemplary operations for a fleet administrator or the like using the vehicle monitoring system 10. The administration method 600 can operate along with the user method 500 and contemplates a similar architecture in the vehicle monitoring system 10. The administration method 600 includes configuring the fleet (step 610). Here, each vehicle 12 is equipped with the monitoring system 20 and configured appropriately, i.e. network access, unique identifiers, etc.

The administration method 600 includes receiving real-time updates from each vehicle in the fleet (step 620). The administration method 600 includes managing the fleet from the back-end system 50 (step 630) and optimizing the fleet (step 640). For example, the administration method 600 can be implemented by a control center to change transportation schedules according to passenger requests at each site. The control center can optimize vehicle routing schedule by adjust it to the actual passenger riding record. The control center can optimize vehicle routing schedule by adjust it to the actual passenger riding record. The control center can download real time vehicle location, vehicle and passenger information. The control center can also provide vehicle operating history real time record to passenger, by using Smart Handheld Device. The system can provide optimized riding option to passenger including minimum distance time.

### Taxi Operations

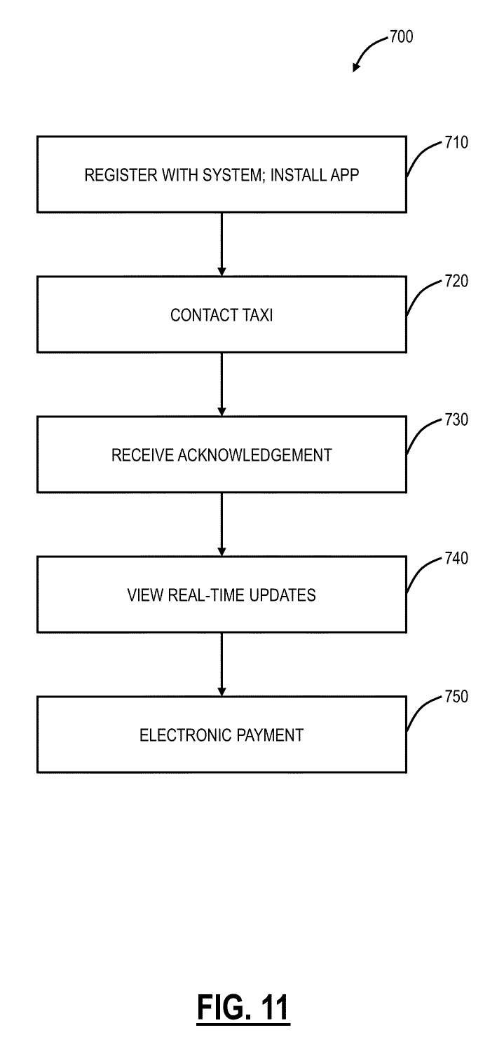

Referring to FIG. 11, in an exemplary embodiment, a flowchart illustrates a user method 700 for a rider and public transportation with the vehicle monitoring system 10. The user method 700 describes exemplary operations for a rider using the vehicle monitoring system 10. Here, various public taxis are equipped with the monitoring system 20 which is communicatively coupled to the back-end system 50. The rider can access the back-end system 50 with the mobile device 200 for performing various functionality such as described in the user method 700. The user method 700 includes registration with the back-end system 50 and/or installing an application on the mobile device 200 (step 710). Here, the rider registers such that the back-end system 50. The parent/student can also install an application (e.g., from the App Store, Android Marketplace, Google Play, Windows Store, etc.) which can provide push notifications, a user interface, etc. with the back-end system 50.

A passenger can send riding request through Smart Handheld Device (step 720) and can receive an acknowledgment (step 730). The passenger can receiver real-time updates while waiting for the taxi (step 740) and electronically pay for the ride (step 750). Based on the actual riding record, passenger will be credit accordingly. Taxi can accept the request by setting the filer, and inform the passenger in real time (including license, car make, arrive time). Passenger can respond to the taxi by confirm, ignore, or declined the message. Once the taxi accepts the request, the vehicle should arrive on time; otherwise credit score will be decreased. The vehicle credit score report is open to passenger.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A fleet management system, comprising:
a monitoring system equipped in each of a plurality of vehicles, wherein the monitoring system comprises a network interface to a wireless network and a location determining device; and
a back-end system communicatively coupled to the monitoring system in each of the plurality of vehicles;
wherein the back-end system is configured to:
communicate with a plurality of passengers to provide real-time updates based on the monitoring system; and
monitor and manage a fleet comprising the plurality of vehicles by an administrator based on data from the monitoring system.

2. The fleet management system of claim 1, wherein the plurality of passengers each comprise a mobile device with an application installed thereon configured to communicate with the back-end system.

3. The fleet management system of claim 2, wherein the back-end system is configured to provide push notifications to the plurality of passengers through the mobile device.

4. The fleet management system of claim 1, wherein the plurality of vehicles each comprise a school bus and the passengers comprise parents and/or students.

5. The fleet management system of claim 4, wherein the back-end system is configured to:
provide location updates to the parents; and
receive information from the parents related to associated students.

6. The fleet management system of claim 4, wherein the back-end system is configured to:
receive the information comprising a student is not riding the school bus.

7. The fleet management system of claim 4, wherein the monitoring system is configured to detect each student on the school bus and the back-end system is configured to notify each associated parent that the student is on the school bus.

8. The fleet management system of claim 4, wherein the back-end system is configured to:
provide detailed school bus Key Performance Indicators (KPI) report by collecting real time data from the monitoring system in each school bus, including cost, student number, maximum riding hours, maximum riding distance, operating cost per bus, and fleet operating cost.

9. The fleet management system of claim 4, wherein the back-end system is configured to:
provide recommendations for fleet management and bus accessories.

10. The fleet management system of claim 4, wherein the back-end system is configured to:
develop a school bus maintenance plan;
change bus rotation schedules; and
notify a maintenance department of any required maintenance.

11. The fleet management system of claim 1, wherein the monitoring system comprises:
a plurality of cameras;
a mobile digital video recorder;
a local data store;
memory;
a processor; and
an interface communicatively coupling the plurality of cameras, the mobile digital video recorder, the local data store, the memory, and the processor.

12. The fleet management system of claim 11, wherein the monitoring system comprises a tamper-proof housing storing the plurality of cameras, the mobile digital video recorder, the local data store, the memory, and the processor.

13. The fleet management system of claim 11, wherein the plurality of vehicles each comprise a school bus and the passengers comprise parents and/or students;
wherein the plurality of cameras comprise a first camera for a driver and an entrance of the school bus, a second camera at a front of the school bus facing seats, a third camera at a midpoint of the school bus, a fourth camera at a rear of the school bus.

14. The fleet management system of claim 11, wherein the back-end system is configured to:
stream real-time video from the plurality of cameras; and
stored recorded video from the plurality of cameras.

15. The fleet management system of claim 1, wherein the plurality of vehicles are part of a public transportation system and the passengers comprise riders of the public transportation system.

16. The fleet management system of claim 15, wherein the back-end system is configured to:
provide schedules to the riders via a mobile device;
optimize routing schedules; and
manage operating history.

17. The fleet management system of claim 1, wherein the plurality of vehicles each comprise a taxi and the passengers comprise riders of the taxi.

18. The fleet management system of claim 17, wherein the back-end system is configured to:
receive a request from a passenger for a taxi;
route the request to the taxi;
notify the passenger of a status of the taxi; and
provide payment from the passenger to the taxi.

19. A fleet management method, comprising:
operating a plurality of vehicles each comprising a monitoring system comprising a network interface to a wireless network and a location determining device;
operating a back-end system communicatively coupled to the monitoring system in each of the plurality of vehicles;
communicating to passengers by the back-end system to provide notifications and updates associated with the plurality of vehicles; and
managing the plurality of vehicles through the back-end system by an administrator.

20. A vehicle monitoring system, comprising:
a plurality of cameras, a mobile digital video recorder, a network interface, a data store, a location determining device, and a processor, each communicatively coupled therebetween; and
memory storing instructions that, when executed, cause the processor to:
process video from the plurality of cameras;
store the video in the data store or provide the video to a back-end system via the network interface; and
provide location updates from the location determining device to the back-end system.
